(19) United States
(12) Patent Application Publication
(10) Pub. No.: US 2014/0278884 A1
(43) Pub. Date: Sep. 18, 2014

(54) Financial Product Management and Bundling System

(71) Applicant: Fifth Third Bancorp, (US)

(72) Inventors: Hollis Schuler, Cincinnati, OH (US); Gary Schnettler, Cincinnati, OH (US); Bill Dowdy, Cincinnati, OH (US); Ramesh Solaiappan, Cincinnati, OH (US); Larry Miller, Cincinnati, OH (US); Moses Mesa, Cincinnati, OH (US); Prabhuprasad Channappa, Cincinnati, OH (US); Jim Cross, Cincinnati, OH (US)

(73) Assignee: FIFTH THIRD BANCORP, Cincinnati, OH (US)

(21) Appl. No.: 13/798,136

(22) Filed: Mar. 13, 2013

(51) Int. Cl. G06Q 30/02

(52) U.S. Cl. CPC G06Q 30/0255
USPC 705/14.27; 705/14.53; 705/14.1

(57) ABSTRACT

A Value Proposition System (VPS) is incorporated into a financial institution's information systems, and acts as a central repository for value propositions that are available from the institution, such as account groups, discounts for minimum balance or transaction volumes, and the like. The VPS uses a data store to collect data relating to those value propositions customers have purchased or enrolled in. The data store is regularly updated by communicating information with other bank systems. This enables the VPS to evaluate value propositions to determine whether customers are qualified for the benefit of a value proposition, or alternatively have lost entitlement to those benefits.

### TECHNICAL FIELD

The present invention relates to information systems for managing financial products of the type offered by banks, investment companies and other financial institutions, and the use of such system to manage combined product offerings.

### BACKGROUND

Financial institutions are a key component of the modern economy, and these institutions traditionally offer a wide variety of financial products which, generally speaking, take the form of a financial service having a specific purpose and intended to serve a particular type of customer. These services extend from a simple savings or checking account, mortgage loans, car loans, unsecured loans such as credit card services and associated consumer loans, to investment/brokerage accounts, Certificate of Deposit accounts, business or personal credit lines, and other products.

In many cases financial institutions offer a group of products at a discounted price, with the purpose of enticing customers to integrate a greater part of their financial activity into a single financial institution. As one example, the assignee of this application, Fifth Third Bank, offers a Platinum Capital Account (PCA), which provides a customer combined checking and brokerage accounts. Fifth Third Bank has also offered other combinations such as Homeowners Plus which couples home mortgage and credit line products. Similar combinations are available from peer institutions. In addition, Fifth Third Bank and peer institutions offer simplifying functions for customers using combined products, such as combined statements for Checking and Savings, Internet Banking systems permitting single-point access to PCA accounts, and the like.

The information systems used by financial institutions typically utilize a main central server storing account data, coupled with various interface platforms for individual products such as credit cards, ATM access, Internet banking, mobile device access, interactive voice response (IVR) access, and the like. These disparate systems must be configured to intercommunicate effectively to implement each product, and must be further individually adapted to implement product combinations. Often the implementation of a product combination is a custom one-time project involving program changes to a disparate variety of systems, with those changes being specific to the combination of products. Thus, the definition of a new combination invokes a substantial information systems effort to implement that product combination, which has imposed delays that have traditionally frustrated sales and marketing branches of financial institutions from aggressively seeking new customers and markets by defining new attractive combinations for those customers and markets. Moreover, because of the programming effort required, existing information systems have been limited in their ability to facilitate marketing of product combinations to existing customers, or facilitate efforts to identify high risk customers based upon product combinations.

### SUMMARY

It is accordingly an object of the present invention to provide an information systems architecture that allows the marketing of a variety of combined financial products to customers as defined by customer or market needs, in a manner that minimizes the limitations and information systems roadblocks to defining and supporting combinations of products, even as those combinations span products in different institutional divisions which are handled by different information system resources, such that product combinations can be defined in ways that best meet customer needs rather than being constrained by information systems concerns.

It is further an object to overcome limitations in known systems for defining and supporting product combinations, enabling the definition and marketing of such combinations, and the display of related information, via each customer interface of the institution (Internet Banking, Mobile Banking etc.).

It is also an object to include functionality permitting the information system to evaluate each customer and the criteria for the product combinations applicable to that customer, to ensure that customers enrolled in the product combinations are meeting stated criteria, such as minimum deposit requirements, combined minimum balance requirements, and the like. Further, the system can identify those customers that are close to qualifying or already qualify for a benefit, so that those customers may be contacted for promotional or marketing purposes or, alternatively, automatically enrolled in product combinations for which they qualify.

It is further an object to permit the exchange of product-related information between a financial institution's various account servicing systems, in order to provide a customer with product combination benefits (for example waived fees, credit card points, higher interest rates, premiums, etc.) to ensure the benefits are appropriately applied across these systems, i.e., the benefits are granted when earned and are not granted when not earned. It is further an object to maintain appropriate benefits in light of changes in product usage, such as the opening of a new account or the closing of an account or payoff of a loan.

In accordance with principles of the present invention, these objects are met by providing a platform, known as a Value Proposition System (VPS), incorporated into the financial institution's information system, which acts as a central repository for Value Propositions that are available from the institution, and a data store for data relating to value propositions which customers have purchased or enrolled in. This new Value Proposition System communicates to track and update value proposition-related information with other bank systems so that value propositions can be sold, serviced and reported on to meet business and customer needs.

A novel aspect of the Value Proposition System is the manner in which it defines a value proposition; a value proposition is not defined specifically as a collection of products such as has been used in ‘bundles’ in the prior art, but rather a value proposition is more broadly conceived. A value proposition may be defined as a combination of accounts such as a checking, savings and credit card, but in addition a value proposition may be defined by any financial requirement or minimum activity in one or more accounts that the Value Proposition System can evaluate for compliance. Because the Value Proposition System implements this broader definition, a value proposition can be defined not only as a collection of products, but also by behaviors in one product, such as a minimum average checking account balance, a specific number of bill payments or ATM transactions, or any combination of any of these items or any other activities or amounts which are known to any element of the financial institution's information systems, so long the required behavior can be programmatically measured from the existing information systems. By permitting greater freedom in the definition of value propositions, the financial institution can realize benefits from far greater flexibility in defining value propositions that drive any of a variety of customer behaviors and appeal to a wide variety of prospective and current customers.

The Value Proposition System supports a wide variety of possible benefits, such as reduced or waived fees, interest rate changes, and the like, and ensures the enforcement of those benefits, and the behavior required to acquire the benefit. Specifically, in accordance with principles of the present invention, the VPS regularly checks the validity of each value proposition enrolled in the VPS, updating the status and delivering output files for the account servicing or other target systems that instruct the delivery of a benefit, or terminate the delivery of value proposition benefits. For example, if a value proposition requires a customer to have a checking, savings and credit card account in order to earn a waiver of monthly checking account fee, the VPS will regularly check every customer enrolled in that value proposition to determine if each customer still has open checking, savings and credit card accounts, and only if so, will instruct a checking account fee waiver. If a customer fails to meet a criterion of a value proposition, the VPS may terminate the value proposition benefit, or may generate an alert to the customer with, for example, a 30 day grace period, after which the fee will no longer be waived. Also, the VPS may identify the criteria of the value proposition which the customer failed to meet and provide guidance on what can be done to return to compliance with those criteria, e.g., by increasing a balance to comply with a minimum requirement. The VPS may also accumulate a record of savings or benefits provided through the use of the virtual product, for later reports to the customer.

Further objects and advantages of the principles of the present invention will be understood upon review of the following detailed description and accompanying drawings, in which:

### BRIEF DESCRIPTION OF THE DRAWINGS

FIG. 1 is a system architecture diagram of a Value Proposition System integrated with other systems of a financial institution; and

FIG. 2 is a flow chart illustrating the regular processing of virtual accounts in the Value Proposition System of FIG. 1.

### DETAILED DESCRIPTION

Referring now to FIG. 1, the information system environment of one implementation of the principles of the present invention can now be explained, for the purpose of providing background to a discussion of the functions of a Value Proposition System.

The Value Proposition System 10 illustrated in FIG. 1, forms a hub for defining Virtual Products (VPs) which implement value propositions relative to the various financial products of the financial institution, and the VPS 10 communicates with the disparate information systems of the financial institution to implement a VP via the communication services of the institution's information system enterprise. The VPS 10 incorporates a VPS database VPS DB 11 containing records for VPS virtual product accounts, and operates a Rule Engine 12 to implement the value propositions for Virtual Products, as discussed below.

VPS 10 provides various services and batch process to manage VPS accounts information.

First, VPS 10 utilizes a Virtual Product Repository 13 to store VPS product details including the applicable rules. The Virtual Product Repository 13 stores the list of Virtual Products and related details offered by the institution, in such a manner that the Virtual Product Repository may be accessed by all the systems of the institution to obtain a list of Virtual Products offered, so that those products may be presented appropriately by the individual systems. In one embodiment the Virtual Product Repository 13 is a database and Java application server which defines all of the Value Propositions. The Virtual Product Repository provides details of value propositions/virtual products to the VPS 10, and further defines products that may provide a particular benefit. For example, if a value proposition permits benefits for “any checking account”, the Virtual Product Repository can be referenced to determine those products which qualify as a “checking account” for the purpose of this rule. If a rule requires a specific checking account type such as “Rewards Checking”, the VPS can find this type in the Virtual Product Repository 13 to obtain details about that particular account type. The Virtual Product Repository 13 thus provides a common glossary for all account types and the underlying services that define those products, permitting wide flexibility in the definition of value propositions based on any of the account types which are known to the enterprise, in a platform independent manner.

The Virtual Product Repository 13 further includes a user interface that permits employees to browse for Virtual Products and, based upon authorization level, change attributes of Virtual Products or add Virtual Products to the Virtual Product Repository 13.

The definition of a Virtual Product includes an identification of the rules to be applied to determine qualification for the benefits of the Virtual Product. Housing this information in a separate application on the Virtual Product Repository 13 enables business agility because new products and value propositions can be defined using the Virtual Product Repository 13 user interface without a rewrite of underlying code; in essence the Virtual Product Repository 13 is meta data for all products supported by the enterprise.

The Rules engine 12 of the VPS 10 may be implemented, in one embodiment, by an open source rules engine such as Drools, or any other rules engine. The Rules Engine evaluates the details of each value proposition against a particular customer's data, evaluating If/Then statement logic for each value proposition using rules defined in the Virtual Product Repository 13 for the product. Rules also determine other attributes such as status changes, grace periods, ownership of a Virtual Product, and the like. The business logic for each value proposition is defined in the Rules engine 12 and may be simple or complex depending on the business rules desired for each value proposition. The rules engine also permits agility since Virtual Product rules may be created or modified by changing rule files rather than changing code.

The database DB 11 is an operational data store for the VPS 10. In order for the VPS 10 to evaluate the conditions of Rules in each value proposition it must reference the information identified by the Rule criteria. The DB 11 stores a copy of this information, obtained from the other operational systems throughout the enterprise. This approach is an alternative to implementing integration between the VPS 10 and the many disparate application systems for real time communication to obtain the required data. VPS 10 can rely upon DB 11 to have data necessary for Rule evaluation, which is collected in, for example, a daily batch process from the disparate systems throughout the enterprise; specifically, detailed information on customers, accounts, transactions and balance information may be collected nightly as needed to make rule evaluations. ETL (Extract, Transform and Load) jobs are run each day in communication with the other connected systems to gather than necessary information and update the database DB 11.

Notably, the database DB 11 must contain all information necessary to evaluate all of the Rules defined for all Virtual Products. So, for example, if Virtual Product type X requires a Checking Account and a Credit Card, then the DB 11 must contain all of the Checking and Credit Card accounts for all of the customers who are owners of Virtual Product type X. This will allow VPS 10 to execute the rules for Virtual Product X to determine which customers are meeting the Virtual Product requirements and which are not. As another example, assume that Virtual Product type Y requires customers to keep $50,000 in assets with the bank across all of their accounts. This requirement means that the ETL jobs must populate the DB 11 with information about all of the accounts that are owned by all of the customers in Virtual Product Y including the balances of those accounts. This will allow VPS to add all of the account balances together to determine if the customer is meeting the $50,000 requirement or not. The amount and type of data contained in the VPS DB 11 will grow over time as new Virtual Products are defined and the number of Virtual Products owned by customers increases. By pre-populating this data in the VPS DB 11 ahead of time, VPS 10 run time can be greatly optimized since all of the information that it needs to do its processing is readily available and properly formatted within the VPS DB 11.

VPS 10 communicates, using the defined communication interfaces particular to the financial institution, with the institutions front end interfaces or channels used by to customers. As illustrated in FIG. 1, these include the following:

Teller System 14, which is the primary customer account servicing application for call center and branch employees, which in one particular implementation provides a link to the Banker system platform 18 (discussed below) when viewing a particular customer's information.

Internet Banking 16, which is the Internet facing web server for providing Internet Banking functionality to customers. Customers use this application to access accounts online.

Banker System Platform 18, which is an internal web application used by branch and call center personnel to capture data required to provide financial needs assessments, recommend products, and initiate and/or complete customer and account opening processes.

Mobile platform 20, which is an Internet facing mobile device server for providing mobile Internet Banking functionality to customers via mobile web browsers or mobile device applications provided by the financial institution.

IVR platform 22, which is a telephone banking interactive voice response used by customers in providing telephone banking including balance inquiry, bill payment, transfers, as well as redirection to customer service personnel.

The VPS 10 further communicates with financial institution core account processing systems, including the following:

Customer Master 24, which is a master repository of customer information and relationships of customers with the financial institution. Customer Master 24 may, in one implementation, be based on the IBM WebSphere Customer Center MDM (Master Data Management) product. Customer Master Database 24 synchronizes customer and account information with the Account Hub 26 (discussed below) in real time and on a batch basis, and works in conjunction with a Data Warehouse 15 which stores data for the financial institution as a whole, and thus is accessible to obtain the data needed by VPS 10.

Account Hub 26 is the core banking platform of the financial institution. Hub 26 aggregates customer and account data to provide fast and coherent inquiry and transactional operations, and synchronizes customer data with Customer Master Database 24. Hub 26 provides an online interface to servicing systems as described herein, and is the primary originations platform for deposit and debit card accounts. Hub 26 provides business and data services via a proprietary, binary protocol using a socket-based interface, and handles ATM transactions and credit/debit card transaction authorization for the financial institution

Reporting systems 28 and Product Systems 30 (such as support for checking (CK), savings (SV), Credit Card (CC), Mortgage, Brokerage and other specific products), which communicate with Customer Master 24 and Hub 26 to support those accounts, also communicate with VPS 10 to implement Virtual Products.

The core component of the Value Proposition System 10 is the Value Proposition also referenced herein as a Virtual Product or VP. Value Propositions are not defined as collections of products, but rather, the conceptual model for a value proposition represents it as a value proposition that can be expressed as follows:

Value Proposition: If eligibility requirement(s) are met then deliver benefit

This approach to defining value propositions ensures support of value propositions that are collections of products as well as value propositions that have other requirements, such as maintaining a minimum balance across all deposit accounts or performing a certain number of transactions per month.

The bundling system is able to support any type of eligibility requirement that it can evaluate based on the inputs available. For example, the requirement could be that the customer has to have a Checking Account, a Savings Account and a Credit Card. Likewise, the value proposition can deliver any benefit for which outputs can be generated to the system that actually delivers the benefits. For example, if the benefit is to waive a fee on a credit card then the system that applies credit card fees needs to integrate with the VPS in some fashion so that it knows which fees to waive. The inputs and integration of the VPS with any target system permits any eligibility requirements defined on that target system to be evaluated and any benefits that can be delivered by that target system to be provided.

This concept for a value proposition provides significantly more flexibility than a simple hierarchical model that assumes that the value proposition is a collection of accounts. As implemented as described below, the VPS evaluates a set of eligibility requirements for each user of a value proposition, based on data from integrated systems, in order to determine whether or not to deliver the benefits to the appropriate integrated systems.

Value Propositions are treated as accounts, just like checking accounts, savings accounts or credit cards, hence the terminology Virtual Product. When a customer enrolls in a value proposition, the VPS creates a new value proposition account and gives it an account number. This account number will be stored in the VPS system along with any other details about the value proposition. The value proposition account number will also be stored in Customer Master 24 which will maintain the customer to value proposition account relationship.

By treating value propositions as just another account type the VPS 10 takes advantage of existing IT infrastructure that already exists to handle accounts. Also, as customers and employees are accustomed to dealing with accounts, modeling a value proposition as another account, assists in the implementation of a value proposition throughout the enterprise.

The value proposition eligibility requirements can potentially represent any conditions that the financial institution system can systematically evaluate. So, for example, a hypothetical Premier Value proposition could be represented like this:

| Value proposition | | |
|---|---|---|
| Name | Eligibility Requirements | Benefits |
| Premier Value | Customer must have a Credit Card, | Double credit |
| proposition | Savings Account and an Equity Line | card reward |
| | | points |

As long as the eligibility requirements are met the customer will receive the benefits. Here are some other examples of conditions that the system could potentially support:
Customer must have a Checking Account, Credit Card and a Mortgage
The 30 day average balance for all deposit accounts must add up to over $100,000
Must have a Gold Checking account, a Brokerage account and perform 3 stock trades per month
Must have a Home Equity Loan, a Goal Setter Savings account (in good standing and with a minimum $1,000 balance) and a World Debit MasterCard
Must have a Dash Card, enroll in direct deposit and perform 3 ATM transactions per month
Must perform 5 ACH Direct Deposits a month

Each value proposition will have a set of associated rules such as those listed above. If the rules are satisfied, then the customer gets the benefits that the value proposition provides. The defined conditions must evaluate to a true or false answer and they must be based on criteria that the VPS 10 has available to it for consideration. For example, if the rule stipulates that the customer needs to be enrolled in an external product, such as a identity theft alerting product, but the VPS has no way of knowing whether the customer has enrolled in that product, then that value proposition rule cannot be enforced until integration with the ID Alert provider is put in place.

A value proposition is simply a value proposition to the customer. If the customer satisfies certain conditions then the customer receives specific benefits. Looking at this statement again:

If eligibility requirement(s) are met then deliver benefit

The eligibility requirement is the behavior or action that the financial institution wants to drive (e.g. more accounts, higher balances, more transactions, etc) and the benefits are what the customer wants (e.g. waived fees, cash bonuses, rewards points, better interest rates, etc).

The systems that will be delivering the benefits need to know when to grant them and when not to. For example, if the benefit for satisfying a particular value proposition's conditions is to get a higher interest rate on a Savings account, then VPS 10 will have to provide information to the appropriate Product System 30 indicating which customers have this value proposition and satisfy the conditions. The Product System 30 will then be able to provide the higher savings account benefit to those customers.

If a customer's actions cause his or her value proposition to fall into an inactive status because they are no longer meeting the conditions of the value proposition, then the value proposition system 10 communicates with the target system to reverse the benefit. VPS 10 is, for this purpose, integrated with all of the systems that provide benefits.

Exemplary benefits include accumulation of loyalty points, enhancement of the accumulation of points for a given customer activity, enabling conversion of points to cash, payments or benefits, or enabling the same at different levels.

Examples of virtual products may include combinations of products, or other relationships. A virtual product may, for example, provide a benefit upon continuous customer status for a calendar year or notable terms of years such as 5, 10 or 20 years.

The VPS may also evaluate current customer activity for applicability of virtual products, and potential qualification for a virtual product. For example, the VPS may identify a customer eligible for a virtual product due to their use of a personal checking account and mortgage, and in such cases may automatically enroll the customer or notify the customer of eligibility automatically. Further, the VPS may determine that a customer could be eligible through the use of an additional product, such as by enrolling for a business checking account.

The VPS can also accumulate data useful for customer retention, such as records of total accumulated benefits offered in conjunction with a virtual product, which can be noted to the customer as a enticement in the event the customer is contemplating termination of a component or activity necessary for the virtual product; moreover, the VPS may also provide combined product statements of the individual products which are components of a virtual product.

In another embodiment, it would be possible to control benefits manually by providing a file or report to a team of operators that then manually adjust interest rates, waive fees, etc. but the automated approach is more desirable whenever possible.

To implement these functions, the VPS 10 generates output files that notify target systems as to whether they should grant the customer the specified benefit or not. The VPS system 10 will also retain this information and provide it back to customers and employees in the form of reporting in statements or via the various customer facing interfaces 14, 16, 18, 20 and 22, so that customers can see the value delivered by the value proposition. This information could, for example, be displayed on Internet Banking 16 or printed on an account statement in order to help the customer better understand the benefits that they are receiving.

Value propositions will always be in one of three states:
Active—the value proposition requirements are currently being met and benefits are being delivered
Inactive—the value proposition requirements are not currently being met and benefits are not being delivered
Closed—the value proposition has been terminated either by the customer or the bank. Benefits are not being delivered.
   These states are supported by the existing account management systems and thus can be implemented within those systems. By limiting the number of states to 3 the task of customers, customer service representatives, operations, programmers and business stakeholders is greatly simplified.

Normally most value propositions should be in the Active status. When customers fail to meet the required conditions the value proposition will fall in to the Inactive status and they will stop receiving benefits. If a customer decides to cancel their value proposition it will be moved into Closed status. Or after a set amount of time (variable by value proposition—perhaps 6 months or a year) inactive value propositions may be systematically be moved into the Closed status. After being in Closed status for a specified time period (most likely several years) the value proposition will be completely removed from the system.

Variations on the three bundling states will be represented by other flags or attributes on the value proposition. For example, a brand new but unfulfilled value proposition could have a state of Inactive, but could have a flag indicating that the reason that it's Inactive is because pending the opening of an account. Another value proposition might be Active (so the customer is still receiving benefits), but it might have a caution flag set if nearing the end of a grace period and an account balance is below the value proposition threshold.

The difference between Active and Inactive value propositions is a key concept of the Value proposition System; Active propositions deliver benefits, whereas Inactive propositions do not.

The VPS 10 also supports the concept of Tiers, which represent different levels of value for meeting different levels of value proposition eligibility, within the scope of a particular value proposition type. The VPS 10 enables a value proposition to have multiple tiers by extending the value proposition concept. Logically a tiered value proposition takes the form:

If (Tier 1 condition) then deliver (Tier 1 benefit)

If (Tier 2 condition) then deliver (Tier 2 benefit)

If (Tier 3 condition) then deliver (Tier 3 benefit)

A hypothetical tiered value proposition could look something like this:

| Value | | | |
|---|---|---|---|
| proposition | | | |
| Name | Tier | Eligibility Requirements | Benefits |
| Asset | 1 | Customer must have a Asset | Free ATM |
| Builder | | Builder Checking and Savings | transactions |
| Value | | Account with combined | |
| proposition | | balances of $10,000 | |
| | 2 | Customer must have a Asset | Free ATM |
| | | Builder Checking and Savings | transactions and |
| | | Account with combined | Free Checks |
| | | balances of $20,000 | |
| | 3 | Customer must have a Asset | Free ATM |
| | | Builder Checking and Savings | transactions, Free |
| | | Account with combined | Checks and double |
| | | balances of $30,000 | interest on Savings |
| | | | Account |

The VPS supports an unlimited potential number of tiers for each value proposition. In order to minimize the amount of churn for accounts that fluctuate from one tier to the other, tiers may be evaluated on a different periodic schedule than is used to evaluate Inactive or Active status, such as once per month. The frequency of this evaluation will be configurable for each value proposition.

As noted above, value propositions hold one of two statuses, either Active or Inactive. To support delays in moving between these two states the VPS 10 supports Grace Periods. Delays might occur as part of lengthy business processes to establish or transfer accounts, or delays might be created to allow a customer time to react to a the failure of a condition of a value proposition condition, before the removal of benefits.

There are two primary cases where Grace Periods are necessary: (1) for new value propositions where time may be needed in order to meet the value proposition requirements and for which the business wants to begin granting benefits immediately. For example, for a value proposition that includes a mortgage it may take 30-60 days for a mortgage to actually become open. (2) Existing value propositions that no longer meet the value proposition criteria, but for which the business wants to continue delivering benefits. For example, the value proposition may require the customer to maintain a $100,000 balance, but they slip to $90,000. The institution may notify the customer of the shortfall and permit 30 days for the balance to return to $100,000 before denying value proposition benefits.

Grace periods can be thought of as extensions to the conditions and rules mentioned previously. A value proposition without a grace period might look like this:

| Value proposition | | |
|---|---|---|
| Name | Eligibility Requirements | Benefits |
| Preferred | Customer must have a Mortgage, | Waive monthly |
| Homeowner Value | a CD and a Checking Account | checking |
| proposition | | account fee. |

But with these rules in place the customer will have to pay their monthly checking account fee until the mortgage is open. To add a Grace Period to allow the customer to get benefits before the mortgage is opened we just need to change the eligibility rules:

| Value proposition | | |
|---|---|---|
| Name | Eligibility Requirements | Benefits |
| Preferred | Either (Customer must have a | Waive monthly |
| Homeowner Value | Mortgage, a CD and a Checking | checking account |
| proposition | Account) | fee. |
| | OR | |
| | (Customer must have a CD, | |
| | a Checking Account and the | |
| | Value proposition must | |
| | be less than 90 days old) | |

This would allow the value proposition to be active right away and the value proposition would remain active as long as the mortgage opened within 90 days. Otherwise it would fall to an inactive status and the customer would lose the value proposition benefits.

The VPS 10 will keep audit tables of all changes in value proposition status. Additionally, the reason for the change in value proposition status will be logged. This will allow both customers and employees to quickly determine why a value proposition is either active or inactive. It will also let them see when benefits should have been delivered and when they should have stopped.

In addition to tracking changes in status (Active, Inactive or Closed) the audit trail will also capture changes in the accounts that are associated with a value proposition. Consider the following example:

Value proposition X:
Requires Gold Checking, any Savings Account and any Mortgage Loan Benefit—waived fees on Gold Checking

Customer Bob has
Gold Checking CK1
Gold Checking CK2
Savings SV1
Savings SV2
Credit Card CC1
Credit Card CC2 and
Mortgage Loan M/L

In this example, Bob has more than enough accounts to meet the value proposition requirements. He selects Gold Checking account CK1 as the account that he wants to receive the value proposition benefits. The VPS will (based on defined criteria) select the savings account (say SV1) and M/L. When Bob logs on to Internet Banking he will see that his value proposition includes his Gold CK1, SV1 and his M/L. If Bob later closes SV1, that's ok. The value proposition can remain in Active status because he still has SV2. At that point the VPS will denote this change in accounts in the audit history tables. Because the VPS is rules based it will be able to handle this type of scenario automatically.

Static Value propositions, of the kind discussed above, are pre-defined. The VPS also supports dynamic value propositions, meaning propositions that are defined on the fly. For example, the Homeowner Plus Virtual Product described above is a static value proposition because it always contains a checking account, a mortgage and a credit card. A dynamic value proposition on the other hand is not pre-defined. Instead a customer could mix and match different combinations of products and services to create their own value proposition. One approach to doing this is to create a point value system where each product selected during enrollment gives the customer a certain number of points that they can apply towards benefits. The customer can then select the specific benefits that they want until they've spent all of their points.

The core software of the VPS 10 may be written in Java and run in both in Online and Batch Mode. The Online component of the application is accessed via Web Services which allow other applications to access VPS 10 to inquire about a Virtual Product, to open a new Virtual Product, to update a Virtual Product or to perform an integrity check (to determine if a Virtual Product is meeting requirements). The batch portion of VPS 10 may utilize, for example, the open source Spring Batch framework. The batch processing will run nightly to evaluate all of the Virtual Products as discussed in more detail below. This processing will do several things (not necessarily in this order):

1. Read through each Virtual Product on the VPS database and will evaluate the status (using the previously mentioned Stored Procedures against the ODS and the rules).

2. Update the Virtual Product records on the VPS database if there is a change in status, if a benefit is earned, there is a change in Virtual Product ownership or any other change is identified during the evaluation process.

3. Management reports are created to provide information regarding how many Virtual Products exist of each type, how many new Virtual Products were opened, have many Virtual Products were closed, how many Virtual Products are in good standing, etc. The management reports business partners make decisions and gauge the success of the various Virtual Products that they define.

4. Operational Reports, which are used for direct actions that need to be taken and they are delivered to operations teams. These teams work the reports and take whatever action is required. For example, an operational report might identify all of the Virtual Products where the credit card rewards are set up incorrectly at Mastercard. The operations team could then work to correct the problem by fixing the rewards point setup at MasterCard's web site. Or the operations team might get a report of all of the Virtual Products that are in danger of being closed because they are not meeting requirements and they may call each customer to inform them of this situation and attempt to resolve it. The reports created for each Virtual Product can be unique and customized for the particular needs of that Virtual Product.

5. Benefits Files are created to deliver benefits information to other systems. In some cases, a new benefit may be identified (such as waiving a fee or providing a discount on a mortgage application) and in other eases a benefit might be taken away (if the customer isn't meeting the Virtual Product requirements). This benefit information also includes details that will be put on customer statements such as how many credit card points, waived fees or other rewards the customer has received over the past month, year or since they've enrolled in the product.

6. Virtual Product Files are created and contain detailed information about all of the Virtual Products. This data is passed to business intelligence systems for use in further analysis beyond the above mentioned management reports. For example, this data is loaded into Marketing Data used by the institution for defining marketing campaigns.

7. Billing Files are sent to the billing system to charge customers fees for the use of certain services. For example, a Virtual Product may itself have a monthly fee that the customer must pay in order to get the Virtual Product benefits. Similarly, VPS may send a billing system a record indicating that it should waive a charge for a particular customer since they are fulfilling their Virtual Product requirements.

8. Alerts will be generated whenever a significant event occurs and the customer needs to be notified. For example, if the customer falls into bad standing, or if they get promoted to the next benefit tier, or if a grace period is about to expire, an alert will be generated and distributed via text message, e-mail or other means.

Note that one fundamental tenant of the VPS solution is that each Virtual Product has its own unique account number, just as checking accounts, savings accounts and credit cards each have their own unique number. By giving a Virtual Product an account number it can be treated as an account itself and therefore it can readily be supported by other banking systems which are designed to process accounts.

Referring now to FIG. 2, the rule-based process followed by the VPS 10 is illustrated in the form of a flow chart; these operations are performed in response to Rules 12 defining each Virtual Product/Value Proposition, operating upon customer account information in database DB 11.

The rule processing takes the form of a periodic review 100, initiated on a periodic basis such as daily, or perhaps weekly or another period. Each periodic review involves a review for each Virtual Product account type (e.g., Homeowner Plus Value and Premier Value as described above), as seen in loop starting after step 102. Furthermore, for each Virtual Product account type, the review involves a review of each customer holding that Virtual Product account type, as seen in the loop starting after step 102.

In a first step 106, the relevant data for a current customer and rules for the current virtual account type are retrieved for analysis. Then, in step 108, the rules defining the virtual account type are applied to the data for the current customer to determine whether the Virtual Product requirements are met. If so, then in step 110 the Virtual Product account is set to active status.

If the rules defining the virtual account type are not met by the current customer, then in step 112 the rules are evaluated to determine whether there is an applicable grace period for the current virtual account type. If so, then in step 114 it is determined whether that grace period has come to an end, or is still active. If the grace period has not yet ended, flow proceeds to step 110 and the account is set active. If, however, the grace period has ended, or there is no applicable grace period in step 112, then in step 116 the customer's Virtual Product account is set inactive.

If the current customer's current virtual account is determined to be active in step 110, then in step 118 the virtual account rules are evaluated to determine if the rules define tiers of benefits that are to be evaluated at the present time. As noted above tiers may not be evaluated with the same frequency as qualification for benefits generally; thus, the tiered benefits rules may not be evaluated during each review of a given customer and account type. If, however, tiered benefits are defined and are to be reviewed, then in step 120 the current customer activity is compared to the tiers defined by the Virtual Product account rules, and the appropriate benefit tier is identified. Whether or not tiers are evaluated, thereafter in step 122, outputs defining the earned customer benefits are generated for transmission to the systems handling the one or more customer accounts where those benefits are to be applied.

After the above steps, processing of a particular customer is complete and in step 123 a log entry is created logging any status changes or benefit changes for the customer and the reasons for those changes, to permit subsequent notification or customer service communication with the customer. Thereafter, in step 124 it is determined whether there is another customer having the same type Virtual Product. If so, processing proceeds to the next customer (step 130) by returning to step 106. If all customers have been processed for the current Virtual Product type, then in step 126 it is determined whether there are any more Virtual Product types to evaluate. If so, processing proceeds to the next Virtual Product type (step 128) by returning to step 104. After all customers for all Virtual Product types have been evaluated, processing continues to step 132 in which the VPS 10 awaits the next periodic review time, at which point flow returns to step 100.

Beyond the processing and management of Virtual Products and benefits, the VPS 10 has a variety of additional capabilities, including opening Virtual Product accounts, providing status information on Virtual Product accounts, determining benefits and sending alerts to customers.

Enrollment services include:
Provide a list of all available value propositions/Virtual Products
Show the attributes of any Virtual Product including benefit information and eligibility requirements
Given a set of products the customer already has, determine what it would take to complete a value proposition. For example, the VPS may parse the rules defining a value proposition to identify the bases on which a customer does not qualify for the proposition and produce a result indicating those reasons; e.g. the VPS 10 may produce an output indicating that the customer needs to get one or two specific types of credit cards, or that they need to add $1,000 to one of their deposit accounts in order to qualify for the Virtual Product.

Once a Virtual Product has been selected the VPS 10 can enroll the customer in the Virtual Product. This action will add the Virtual Product to the customers list of accounts in Customer Master Database 24. A Virtual Product status update function will then determine if the Virtual Product is active or inactive (since the customer may not meet all of the requirements immediately). If the VPS can determine that all of the Virtual Product requirements are met in real time then it will mark it as active.

The VPS 10 provides visibility to show customers and employees which Virtual Products a customer has and what the status is. The VPS integrates with other customer facing systems such as 14, 16, 18, 20 and 22 (FIG. 1) to offer services that will provide this visibility. Specifically, the VPS will be able to do the following:
Provide data which shows which Virtual Products a customer has. This data will be kept in Customer Master 24 so any connected application will have access to this information.
Show details about the Virtual Product. This will include information such as:
   Virtual Product status (active, inactive or closed)
   Indication of which accounts are connected to the Virtual Product
   Warnings if a Virtual Product is in jeopardy of becoming inactive (e.g. if nearing the end of a grace period), as developed in the status changes logged in step 123 of FIG. 2
   Information about any benefits accrued (e.g. points balance)
   For inactive Virtual Products, information about why it's inactive (e.g. account is below a minimum balance, a required account is closed or missing, etc.) as developed when changes are logged in step 123 of FIG. 2
   Historical information such as when a Virtual Product became active or when it switched Tiers, as developed when changes are logged in step 123 of FIG. 2
      Note that some of the above information may also be stored another system such as Customer Master 24 or Hub 26 for availability and performance reasons.

Benefit-related messages generated in step 122 of FIG. 2 may be delivered as batch processing files to the relevant Product Servicing Systems 30 for this purpose. For example, a file could be sent identifying all of the accounts for which the monthly fee should be waived. For systems that are not prepared to accept such a file, VPS 10 may generate a report 28 for operations personal to manually work into a nonintegrated system to deliver the identified benefits. Similarly, feeds may be delivered to user facing systems so that users can generate their own defined reports.

VPS 10 will include an event engine driven by the logged information created in step 123 of FIG. 2, allowing notification of customers if and when a customer's Virtual Product changes status. These notices may indicate that a benefit has been lost or a benefit has been earned, or both. The notification to customers may potentially be done via e-mail, regular mail, SMS text alert, an alert on their Internet Banking login screen, or as an alert in Banker System 18 to be communicated by customer service personnel.

As mentioned previously, Virtual Products are considered to be just another account type. Virtual Product accounts are stored in the Virtual Product Repository 13 and will have attributes (e.g. product codes, affiliates, start and end date, etc.) just like all of the other financial products of the institution. Additionally, each product type has attributes that are unique to that product type—for example, mortgages have fields that are specific to mortgages and Virtual Products have fields that are specific to those Virtual Products.

The database DB 11 in the VPS 10, includes details on every Virtual Product account that has been opened. Each will have an account number and will be tied to a customer (or customers) in Customer Master Database 24. These records include all relevant information about a particular customer's Virtual Product including the current Status, audit history, information regarding any Virtual Product eligibility rules that have been violated, and so on, as constructed by the process shown in FIG. 2. Benefit data is also included in this database to enable the customer to view actual value from the Virtual Product.

The Rules engine 12 implements the Virtual Product requirements, as stated above. The format of the rules permits flexible use of rules to define a Virtual Product and value proposition. A hypothetical example of three Virtual Products and a mapping to rules is provided below:

| Product Repository Virtual | |
|---|---|
| Product Name | Associated Rules Number |
| Premier | 1 |
| Preferred Homeowner | 2 |
| VIP | 3, 4 |

| Rules | |
|---|---|
| Engine Rule | |
| Number | Rule |
| 1 | Customer must have a Credit Card, Savings Account and an |
| | Equity Line. |
| 2 | Customer must have a Mortgage, a CD and a Checking |
| | Account. |
| 3 | Customer must have a Checking and Savings Account. |
| 4 | Customer must have over $50,000 in their deposit accounts. |

The VPS 10 rules engine 12 uses the mappings in the Virtual Product Repository 13 to determine which rules to enforce for each Virtual Product, and then uses the rule definitions in the rule engine 12 to evaluate qualification of a customer for a value proposition. Thus, in the illustrated example, for the VIP Virtual Product both rule 3 and 4 must be satisfied in order for the customer to get the benefits of the Virtual Product, whereas only rule 1 is required for the Premier Virtual Product and only rule 2 is required for the Preferred Homeowner Virtual Product.

While a batch mode of operation of the Rules Engine 12 is illustrated in FIG. 2, the Rules Engine 12 is also capable of running in a real-time mode. The real-time mode is used to determine Virtual Product eligibility on demand, e.g., during a customer service interaction with a customer via Teller System 14. Otherwise, the rules engine will be heavily used by the batch process, because this process operates repeatedly to reevaluate Virtual Product status on a regular basis.

While the present invention has been described in connection with a number of embodiments and implementations, the present invention is not so limited but covers various obvious modifications and equivalent arrangements, which fall within the purview of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An information system for a financial institution for managing customer relationships, comprising
an account information database storing customer account information for financial service products of the financial institution, each account including at least an identification of a customer and an account status;
at least two product systems each comprising at least one computer processor using account information in the account information database to implement at least two different financial products using accounts in said account information database;
a virtual product repository database storing data defining virtual products to be offered to customers of the financial institution, the data defining a virtual product including (i) an identification of at least one financial product of the financial institution implemented by a product system, (ii) at least one rule applicable to a customer's use of that financial product to qualify for the virtual product, and (iii) at least one benefit in the form of modified terms of a financial product of the financial institution;
a virtual product rules engine comprising stored rules which evaluate a particular customer's use of a financial product;
a virtual product server comprising at least one computer processor programmed to access data of a virtual product in the virtual product repository database and access stored rules for the virtual product, the processor retrieving for a defined financial product, a defined rule applicable to a particular customer's use of that defined financial product, and a defined benefit of the virtual product, the processor of the virtual product server evaluating the particular customer's use of the defined financial product in accordance with the accessed rule defined for a virtual product, and if the customer's use is in accordance with the defined rule, the processor of the virtual product server further directing a processor of a product system to modify terms of the defined financial product in accordance with the defined benefit.

2. The system of claim 1 wherein the virtual product server evaluates a particular customer's activity with respect to a plurality of virtual products.

3. The system of claim 1 wherein the virtual product server responds in real time to a request to evaluate one or more rules for a virtual product for a particular customer.

4. The system of claim 1 wherein the virtual product server performs a batch process of evaluating rules of virtual products for each of several customers that seek qualification for benefits associated with those virtual products.

5. The system of claim 1 wherein the virtual product server comprises an application programming interface permitting a query as to a virtual product and whether a particular customer qualifies for benefits of the virtual product.

6. The system of claim 1 wherein data defining a virtual product identifies two or more financial products and rules applicable to each of said financial products.

7. The system of claim 1 wherein the rule applicable to a customer's use of the financial product defines a minimum balance of an account or a plurality of accounts taken in combination.

8. The system of claim 1 wherein the rule applicable to a customer's use of the financial product defines a minimum number of transactions in an account or a plurality of accounts taken in combination.

9. The system of claim 1 wherein the rule applicable to a customer's use of the financial product defines a minimum average balance of an account or a plurality of accounts taken in combination.

10. The system of claim 1 wherein the modified terms of the benefit are a reduction in or waiver of an account fee.

11. The system of claim 1 wherein the modified terms of the benefit are a change in an interest rate of an account.

12. The system of claim 1 wherein the modified terms of the benefit are a change in the rate of accumulation of points in a customer reward program in response to customer activity.

13. The system of claim 1 wherein there are multiple alternative modified terms of the benefit, each comprising a tier of benefit, the particular tier of benefit being selected in accordance with a defined rule applicable to the amount of a particular customers use of the defined financial product.

14. The system of claim 1 wherein the virtual product server is enabled to regularly check the applicability of a virtual product to a plurality of customers, and generates a current status for each said customer.

15. The system of claim 14 wherein virtual product server delivers an output file instructing the delivery of a benefit, or termination of a benefit for a particular customer.

16. The system of claim 14 wherein the virtual product server causes the delivery of a reminder to a customer of a potential change in status.

17. The system of claim 14 wherein the virtual product server identifies a change in benefit for a customer in response to the customer's opening of a new account.

18. The system of claim 14 wherein the virtual product server identifies a change in benefit for a customer in response to a closing or payoff of an account.

19. The system of claim 14 wherein the status for each customer identifies the activity of the customer that caused a virtual product to be applicable to that customer.

20. The system of claim 14 wherein the virtual product server enrolls a customer for a virtual product for which the customer qualifies but is not already enrolled.

21. The system of claim 14 wherein the virtual product server identifies a product for which a customer may be able to qualify with incremental change in the customer's activity, and delivers a description of that incremental change with the customer's status.

22. The system of claim 1 wherein the virtual product server maintains a history record of the status of a customer's qualification for a virtual product over a historical period, the history record including a description of the reasons that the customer did or did not qualify for the virtual product during the historical period.

23. The system of claim 1 wherein the virtual product server responds to a request to evaluate one or more rules for a virtual product for a particular customer by identifying the failed criteria of the rule and necessary steps that can be taken to eliminate the failure.

24. An information system for a financial institution for managing customer relationships, comprising
an account information database storing customer account information for financial service products of the financial institution, each account including at least an identification of a customer and an account status;
at least two product systems each comprising at least one computer processor using account information in the account information database to implement at least two different financial products using accounts in said account information database;
a virtual product repository database storing data defining virtual products to be offered to customers of the financial institution, the data defining a virtual product including (i) an identification of at least one financial product of the financial institution implemented by a product system, (ii) at least one rule applicable to a customer's use of that financial product to qualify for the virtual product, and (iii) at least one benefit in the form of modified terms of a financial product of the financial institution; and a virtual product rules engine storing rules which evaluate a particular customer's use of a financial product;
a virtual product server comprising at least one computer processor programmed to access data of a virtual product in the virtual product repository database and access stored rules for the virtual product, the processor retrieving for a defined financial product, a defined rule applicable to a particular customer's use of that defined financial product, and a defined benefit of the virtual product, the processor of the virtual product server evaluating the particular customer's use of the defined financial product in accordance with the accessed rule defined for a virtual product, and maintaining a history record of the status of a customer's qualification for a virtual product over a historical period, the history record including a description of the reasons that the customer did or did not qualify for the virtual product during the historical period.
